(19) United States
(12) Patent Application Publication
(10) Pub. No.: US 2003/0169179 A1
(43) Pub. Date: Sep. 11, 2003

(54) Downhole data transmisssion line

(76) Inventor: Jewell D. James II, Brookside Village, TX (US)

Correspondence Address: Gilbreth & Associates, P.C., P.O. Box 2428, Bellaire, TX, 77402-2428, US

(21) Appl. No.: 10/095,903

(22) Filed: Mar. 11, 2002

(51) Int. Cl. H01B 1/00

(52) U.S. Cl. 340/854.9; 174/68.1

(57) ABSTRACT

The invention consists of a downhole data transmission line, and a method of making the same, having at least one polymeric or glass fiber, a first containment tube surrounding the fiber, a conductive material wrapped or braided around the first tube, a layer of insulating material covering the conductive material, and a second containment tube surrounding the insulating material. The downhole transmission line preferably uses optical fibers, a stainless steel first and metal alloy second tubes, copper braiding for the conductive material, thermoplastic for the insulating material, and a protective layer surrounding the outer second tube. A well for producing oil or gas from an oil or gas reservoir that includes the data transmission line and a system for sensing and recording physical parameters over an extended distance that includes the data transmission line are described. The invention also includes methods of using the data transmission line.

### FIELD OF THE INVENTION

This invention generally relates to a downhole data transmission line. More particularly, the present invention relates to a transmission line having one or more optical fibers and electrical conductors, apparatus including such transmission line, methods of making such transmission line, and methods of using such transmission line.

### BACKGROUND OF THE INVENTION

Well monitoring is known in the art for providing measurements of properties of earth formations penetrated by wellbores. It provides information about how efficiently hydrocarbons are being removed from a well, and this data can be used to optimize production. This can help avoid problems that may occur during production, and often allows operators to deal with potential problems before they become serious enough to require drastic or immediate solutions.

Well monitoring includes inserting measuring instruments into the annulus, the wellbore, or elsewhere in the well formation, with these instruments being connected to one end of an armored electrical cable. The armored electrical cables known in the art typically comprise at least one insulated electrical conductor which is used both to supply electrical power to the instruments or tools and to transmit signals generated by the instruments to other equipment located at the earth's surface for decoding and interpreting the signals.

The signals generated by the instruments for transmission to the earth's surface are often electrical signals. The signals can be in the form of frequencies, analog voltages, or digital pulses. It is also known in the art to provide optical fibers in well monitoring cables to enable use of optical telemetry, which is capable of much higher data transmission rates than in electrical signal transmission.

For example, U.S. Pat. No. 4,696,542 issued to Thompson describes a well logging cable having optical fibers disposed substantially centrally within helically-wound, copper-clad steel conductors, the conductors themselves covered by two layers of contra-helically wound steel armor wires. A drawback to the well logging cable described in the Thompson '542 patent is that the optical fibers are encased in a plastic tube. Well logging cables can be exposed to hydrostatic pressures and to temperatures in the wellbore that are high enough to preclude the use of the plastic tube as disclosed in the Thompson '542 patent. Another problem is that the helically wound armor does not provide a smooth service for sealing connections between the cable and downhole equipment. This is also a problem at bulkheads or any other equipment through which the cable must pass without creating a leak path for high-pressure fluids or gas.

A combination fiber-optic/electrical well logging cable having the optical fiber enclosed in a steel tube is disclosed for example in U.S. Pat. No. 4,522,464 issued to Thompson et al. The cable disclosed in the '464 patent provides an optical fiber enclosed in a steel tube disposed in the center of a well logging cable. This has the same drawbacks as the '542 patent since it lacks a smooth outer surface for creating high-pressure seals. In addition, the use of conductors large enough to simultaneously serve as armor around the interior fibers adds considerable bulk to the design.

Another hybrid cable design includes U.S. Pat. No. 5,892,176 to Findlay, et al. which discloses a cable having a length of fiber optic in parallel arrangement with an electrical conductor, both of which are encapsulated in an insulating material so as to form a core. This design, however, suffers many drawbacks when compared to the present invention. For example, the cable design of the '176 patent has space constraints that will require either (a) a larger outer tube (requiring more material and occupying more space) or a thinner-walled outer tube (so that it will be weaker and provide less protection for the core), or (b) less filler material (meaning less insulation for the electrical cable and less overall protection for the complete core). Also, the parallel design will make it impossible to centralize the conductor and the fibers, thereby limiting the ability to minimize overall capacitance and signal interference. Finally, there may also be termination difficulties since it will be necessary to design separate terminations side by side rather than a single termination that includes a simple feed-through for the fiber.

Another hybrid cable design is described in U.S. Patent Application Publication 2002/0001441-A1 to Avallanet. Avallanet discloses a hybrid cable having an optical fiber positioned in a metal tube with seven or more electrical conductors twisted about the tube to form a multifilament twisted rope, the rope then being drawn or swaged to reduce its diameter. Avallanet's cable, however, is not designed such that a single conductor and the outer sheathe can be used to complete an electrical circuit without additional conductors. Avallenet will also most likely face similar sealing problems to those previously discussed in connection with the Thomson '542 patent. Moreover, it is unlikely that the swaged or drawn components in the Avallenet design could survive the harsh conditions in a petroleum well without a solid outer jacket made of a material appropriate for these conditions.

Accordingly, there is a need for an improved downhole data transmission line that can transmit electrical and optical signals in harsh wellbore conditions without the constraints and design drawbacks described above.

### SUMMARY OF THE INVENTION

The present invention is directed to a downhole data transmission line having at least one polymeric or glass fiber, a first containment tube surrounding the fiber, a conductive material wrapped or braided around the first tube, a layer of insulating material covering the conductive material, and a second containment tube surrounding the insulating material.

In one embodiment, the data transmission line also includes a second layer of insulating material covering the conductive material. In another embodiment, the data transmission line includes an epoxy resin injected between the layer of insulating material and the second tube. In another embodiment, the data transmission line includes at least a second or more conductive material layer wrapped or braided around the first tube. And in yet another embodiment, the data transmission line includes a layer of insulation separating each of the conductive material layers.

The downhole transmission line preferably uses optical fibers, metal first and second tubes, copper braiding for the conductive material, thermoplastic for the insulating material, and a protective layer surrounding the outer second tube.

The present invention also includes a method of making a downhole data transmission line that includes the steps of providing at least one polymeric or glass fiber, surrounding the fiber with a first containment tube, wrapping or braiding a conductive material around the first tube, covering the conductive material with a layer of insulating material, and surrounding the insulating material with a second containment tube.

In addition, the present invention includes a well for producing oil or gas from an oil or gas reservoir that includes the data transmission line described herein, and a system for sensing and recording physical parameters over an extended distance that includes the data transmission line described herein. The present invention also includes methods of using the data transmission line described herein.

The foregoing has outlined rather broadly the features and technical advantages of the present invention so that the detailed description of the invention that follows may be better understood. Additional features and advantages of the invention will be described hereinafter, which form the subject of the invention. It should be appreciated by those skilled in the art that the conception and the specific embodiments disclosed might be readily used as a basis for modifying or designing other data transmission lines for carrying out the same purposes of the present invention. It should also be realized by those skilled in the art that such equivalent constructions do not depart from the spirit and scope of the invention as set forth herein.

### BRIEF DESCRIPTION OF THE DRAWINGS

The accompanying drawings, which are incorporated in and form a part of the specification, illustrate the embodiments of the present invention, and, together with the description, serve to explain the principles of the invention. In the drawings:

FIG. 1 illustrates, in an enlarged scale, a length of a downhole data transmission line of the present invention with components of the data transmission line removed to show underlying layers and elements;

FIG. 2 is a transverse cross-sectional view of the data transmission line of FIG. 1;

FIG. 3 is a transverse cross-sectional view, in an enlarged scale, of another embodiment of a downhole data transmission line in which the core is not centralized;

FIG. 4 is a transverse cross-sectional view, in an enlarged scale, of another embodiment of a downhole data transmission line having an additional layer of braid; and

FIG. 5 is a transverse cross-sectional view, in an enlarged scale, of another embodiment of a downhole data transmission line having multiple layers of braid and insulation.

It is to be noted that the drawings illustrate only typical embodiments of the invention and are therefore not to be considered limiting of its scope, for the invention will admit to other equally effective embodiments.

### DETAILED DESCRIPTION OF THE INVENTION

In general, the present application describes a downhole data transmission line having one or more optical fibers surrounded by an insulation-covered, copper braided stainless steel tube. This insulation-covered, copper braided inner tube is either (1) covered by another layer of insulation material and then surrounded by an outer metal alloy tube, or (2) surrounded by an outer metal alloy tube, before which an epoxy resin is injected between the first layer of insulation material and the outer tube.

The present application also describes methods of making such data transmission line, apparatus including such data transmission line, for example, a well for producing oil or gas from an oil or gas reservoir or a system for sensing and recording physical parameters over an extended distance, and methods of using such data transmission line.

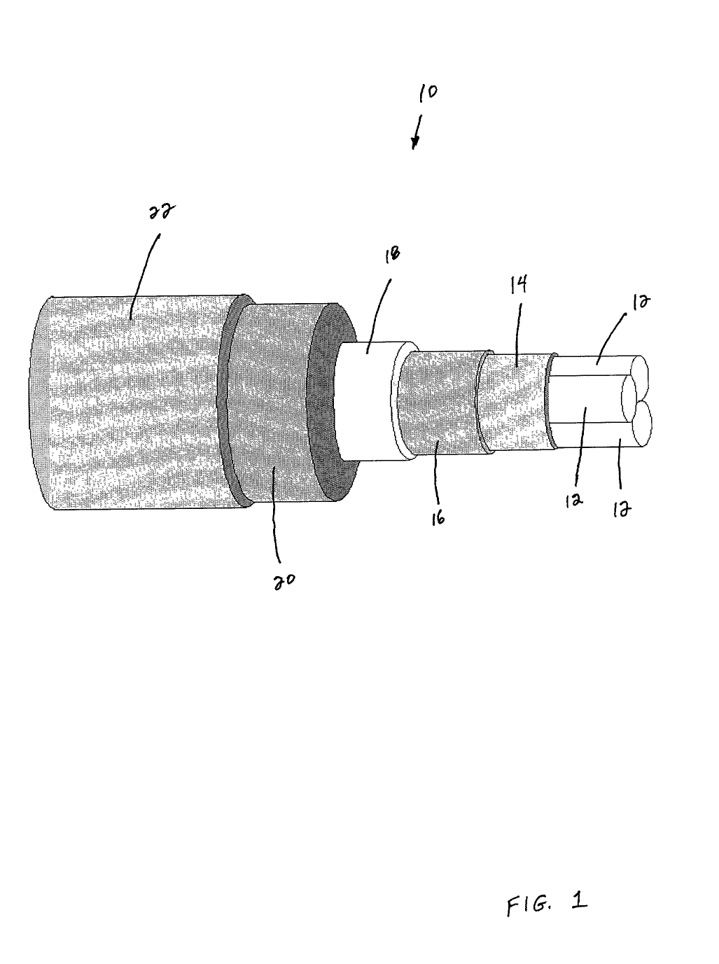

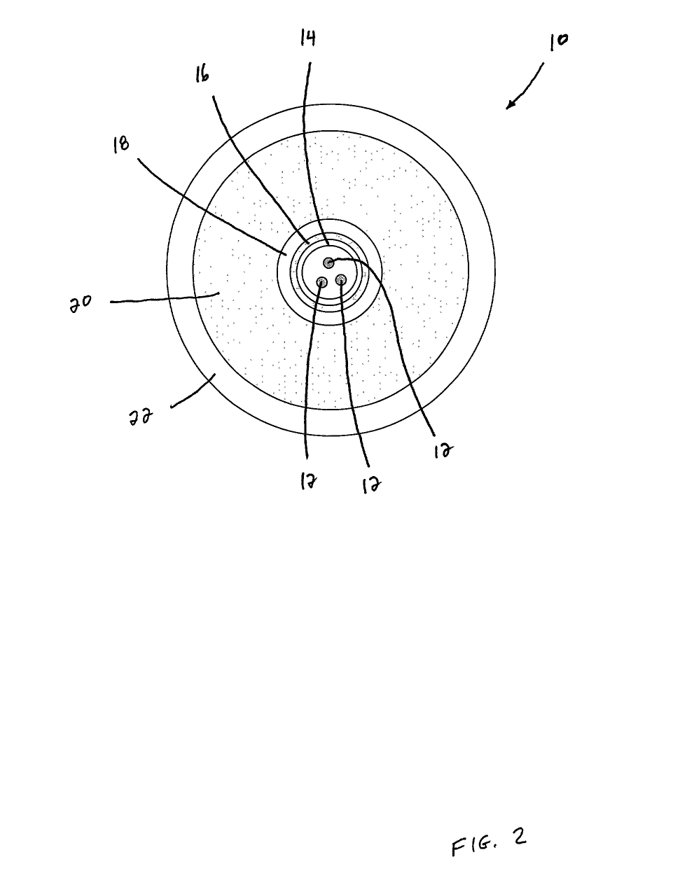

Referring to all the figures, but principally to FIGS. 1 and 2, a downhole data transmission line for concurrently carrying optical signals and electrical signals is generally indicated by reference numeral 10. While the line 10 will be described with specifics regarding its overall size, dimensions, and materials used to fabricate the line, the present invention is not intended to be limited solely to these specifics nor to only downhole data transmission applications.

To begin, the transmission line 10 has a substantially uniform cross section throughout its length and comprises one or more optical fibers 12 sheathed in a small metal containment tube 14. The optical fiber or fibers 12 may be single-mode or multi-mode fibers, or mixtures thereof, with a step index or a graded index fiber type. The fibers are preferably high temperature, multi-mode fibers. Even more preferably, the fibers are size 50/125/400/700 um fibers manufactured with Si/PFA materials by Sumitomo. Such fibers have a strength rating of 100 kpsi, a temperature rating of 200 degrees C., and an attenuation of 1 db/km at 1300 nm, 400 MHz. The fibers may have a protective buffer layer or a hydrogen-scavenging gel such as Sepigel H 200 LWT, if desired.

While the fiber is typically used in well monitoring to transmit data between two devices (from a downhole sensor to an uphole processor), the fiber itself may serve as the sensor. In such a practice, a surface device sends a signal down the fiber even though it is not terminated to a device at the other end. Partially reflected bits of the signal echo back up the line and the same surface device collects this data. Well conditions affect the properties of the fiber, the fiber causes variations in the reflected signal, and these variations can provide valuable information about the well.

The small metal containment tube 14 may have an outer diameter (OD) from about 0.034 inches to about 0.071 inches, preferably 0.052 inches, and be made of stainless steel, such as a 304SS, 316SS, or an alloy such as A625 or A825, preferably a 304SS tube. As can be appreciated by those skilled in the art, the tube 14 will conduct electricity, but its conductive properties are not sufficient for most permanent monitoring systems. A tube manufactured from any of these materials can withstand pressures in excess of 15,000 to 20,000 psi and will have minimum bend radii from 10 to 12 inches depending on size. The tubes are also strong enough to terminate in electrical applications as if they were regular conductor wire.

For most applications, the combination of the fiber or fibers 12 sheathed within the small metal tube 14 is an off-the-shelf product available from known suppliers such as Laser Armor Technologies or one of their affiliates. Alternatively, instead of buying the combination off-the-shelf, the stainless steel tube 14 may be laser welded longitudinally about the fiber or fibers 12. Moreover, while the tube 14 has been illustrated as being a substantially smooth hollow cylinder, it may be corrugated if desired, or take other geometric shapes appropriate for the application.

The metal tube 14 is wrapped or tightly braided in a highly conductive material 16. The conductive material 16 is preferably a tinned copper braid. The amount of copper in the braid will allow it to act as an equivalent to 16 AWG solid copper. As is appreciated by those skilled in the art, any conductive material (such as silver, copper, gold, aluminum, or the like) will work, but copper is most readily available and is cost effective. Of course, a variety of braided designs can be used including flat tinned copper braid, tubular tinned copper braid, oval tinned copper braid, or silver-plated copper braid—having a flat width from 1/64 inch to 2 inches, a nominal thickness from 0.01 inch to 1.00 inch, from 1 to 100 wires per strand, and an approximate AWG equivalent from 1 to 24—depending upon the current carrying capacity desired. The small tube/conductor combination is then encapsulated or covered with an insulating material 18, such as thermoplastic polyolefin or fluorinated ethylene propylene (FEP) jacket, which insulates the copper braid 16 from the rest of the downhole data transmission line. As is appreciated in the art, braiding and insulating are common procedures for many electrical cables. The outside diameter of the line at this stage of manufacture is from about 0.064 inches to about 0.194 inches, preferably 0.130 inches OD. As can be appreciated by those skilled in the art, the dimensions given are for use with a 0.25-inch outer tube—the use of a smaller or larger outer tube will cause proportional changes in the dimensions of the other components of the transmission line.

This insulated tube can have a secondary layer of material 20 applied if necessary, depending on the next stage in production, and can be referred to as the “core” of the data transmission line. The secondary layer of material is extruded over the insulated tube assembly to have an OD approximately equal to the ID of an outer tube 22 that is added at the next stage of manufacture.

Specifically, at the next stage of manufacture, a large metal tube 22 is welded around the insulated tube assembly. The tube 22 most commonly used is 316SS or A825, and is preferably 0.25 inch OD with 0.028, 0.035, or 0.049 inch wall thickness. Most preferably, the tube is 0.25 inch OD, 0.035-inch wall thickness, A825. A825 is preferred because of its strength and resistance to corrosion, even at high temperatures. As is appreciated in the art, most downhole components are required to comply with standards such as NACE MR-0175 (for corrosion), and A825 meets this standard, even at high temperatures where many grades of stainless steel will not qualify. A825 is also readily available and more easily welded than some of the more exotic steel alloys. The tube 22 serves as armor to protect the core, and can serve as a return path to complete the electrical circuit between the uphole computer (not shown), the core conductors, and the downhole sensor (not shown). If the core has a secondary extrusion, the tube is welded so that the ID of the tube 22 is approximately equal to the OD of the core, or preferably larger so that it is slightly compressed during manufacture, and centralizes the core in the larger tube. Such a configuration is shown in FIG. 2.

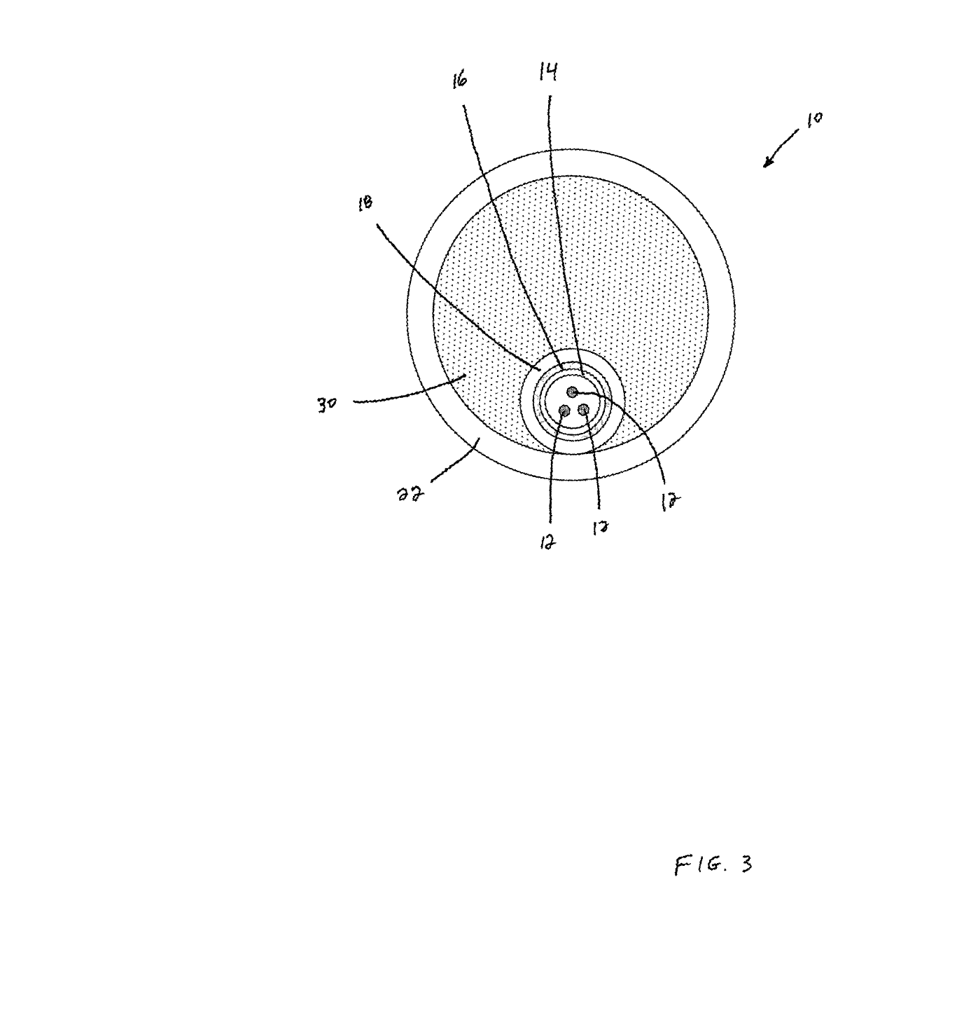

If the core has only the first layer of insulation, it fits loosely in the large tube 22 and an epoxy resin 30 is injected into the large tube 22 to lock the core in place. The epoxy resin serves to support the core in the tube so that in a vertical installation the entire weight of the core is not pulling downward on the uphole cable termination. The resin also impedes the migration of gas or fluid upwards through the cable to the surface. In this embodiment, as illustrated in FIG. 3, the core is not centralized in the large tube 22. One advantage to this embodiment is that the large tube can be fully pressure tested before resin injection. Pressure testing may be conducted to assess or guarantee the integrity of the weld in the outer tube. If there are flaws in the tube it is likely that the core can be damaged in the harsh downhole conditions, so a pressure test reduces the risk of system failure.

With either embodiment, while the large tube 22 has been illustrated as being a substantially smooth hollow cylinder, it may be corrugated if desired, or take other geometric shapes appropriate for the application.

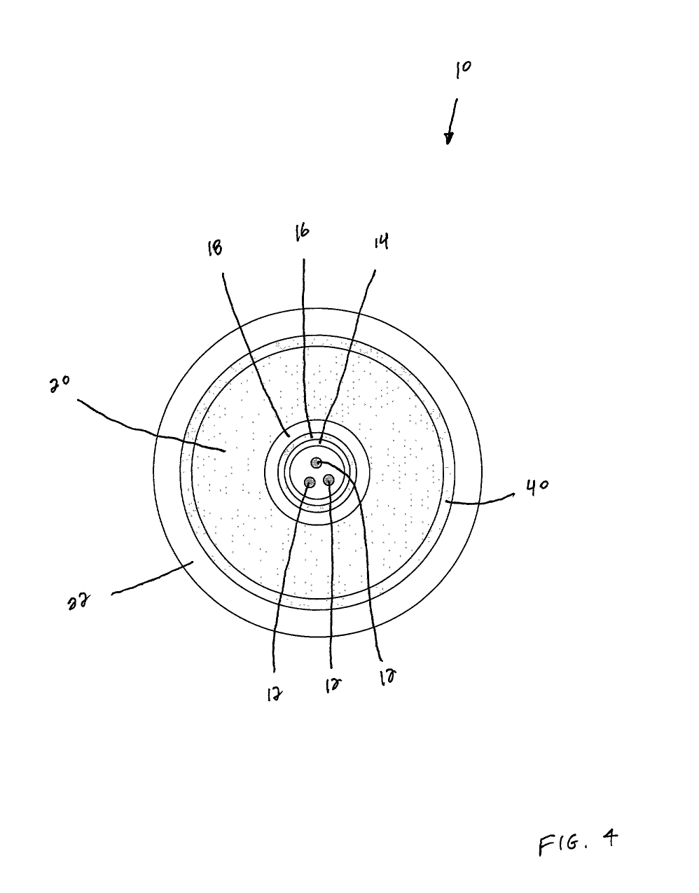

Turning now to FIG. 4, there is shown a fiber optic/electrical data transmission line with an additional copper braid 40 that increases the conductivity of the large (outer) tube 22. The functionality of this design is generally similar to the others, except that it will have a greater conductivity in the return path because the return path is now a combination of the A825 outer tube and the copper braid just inside it. This will improve electrical performance for high current or high frequency systems, if required.

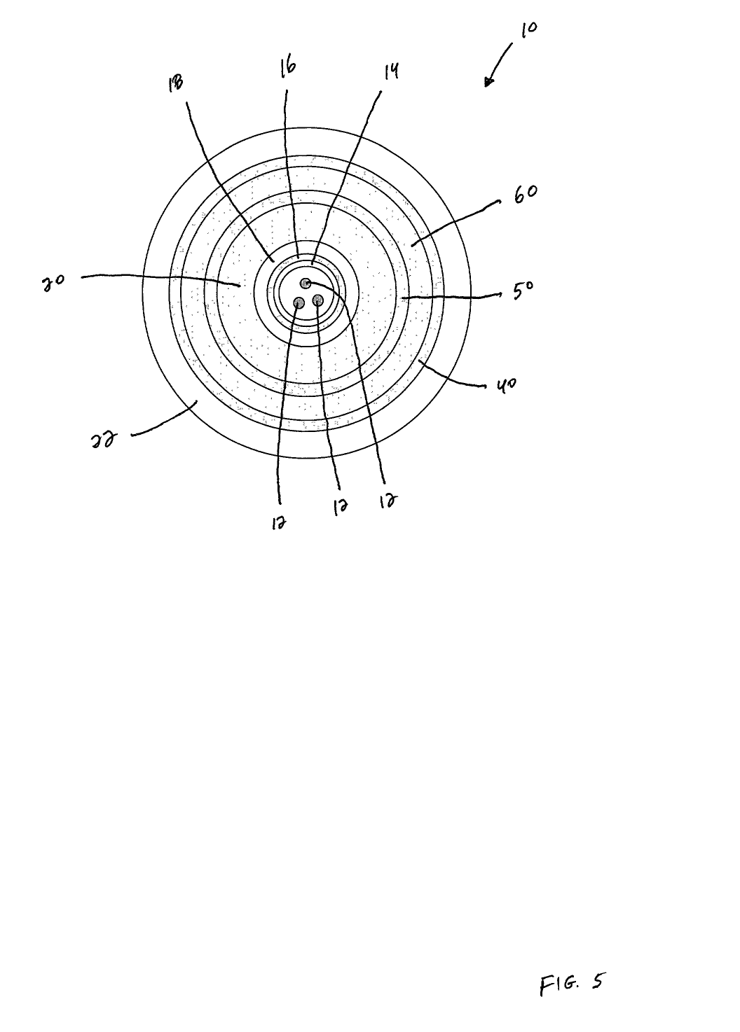

Moreover, if desired, it is possible to layer one or more braids 50 and one or more insulation layers 60 to give multiple isolated conductors. Such an embodiment is shown in FIG. 5. This embodiment isolates several different conductors without requiring that they all run side by side.

Finally, in most applications, the large tube/core assembly shown in FIGS. 1-5 will have a final extrusion applied, for example, a thin encapsulation of a protective layer formed from suitable plastic materials such as high density polyethylene or polypropylene (Santoprene), to produce the finished product. This protective layer may of course be color coded or otherwise differentiated, labeled or marked with appropriate usage or material of construction notations, or provided with some other product indicia known in the art.

The downhole data transmission line fabricated in accordance with the present invention theoretically can have an infinite length and may be used underground, aboveground, undersea, or in any other environment. For example, the conditions within a well to which the downhole data transmission line is exposed can be quite harsh, with hydrostatic well pressures in excess of 20,000 psi and ambient well temperatures exceeding 300 degrees Fahrenheit. Wells may also contain caustic fluids or sharp objects that can cause transmission line deterioration or physical damage. And, while the transmission line fabrication process has been described primarily as being a continuous in-line process, some of the transmission line fabricating steps may be performed off-line or in a discontinuous fashion.

The data transmission line of the present invention can be included in many apparatuses and systems. For example, a well for producing oil or gas from an oil or gas reservoir could incorporate the transmission line described herein. The transmission line can be constructed and arranged to pass between the casing and the production pipe. Likewise, a system for sensing and recording physical parameters over an extended distance could incorporate the transmission line described herein, the transmission line serving to connect the sensing means with the recording means.

In addition, the present invention contemplates a method of using the data transmission line that includes measuring the properties of earth formations penetrated by wellbores with one or more instruments, the instruments generating signals in response to the properties of the earth formations, and transmitting the signals with the data transmission line described herein to a computer for processing and interpretation of the signals.

Although the present invention and its advantages have been described in detail, it should be understood that various changes, substitutions, and alterations could be made herein without departing from the spirit and scope of the invention as defined by the appended claims.

What is claimed is:

1. A transmission line comprising:
at least one polymeric or glass fiber;
a first containment tube surrounding said fiber;
a conductive material wrapped or braided around said first tube;
a layer of insulating material covering said conductive material; and
a second containment tube surrounding said material.

2. The transmission line according to claim 1, wherein said fiber is of optical quality.

3. The transmission line according to claim 1, wherein said first tube is comprised of stainless steel.

4. The transmission line according to claim 1, wherein said conductive material is comprised of copper braiding.

5. The transmission line according to claim 1, wherein said insulating material is comprised of a thermoplastic.

6. The transmission line according to claim 1, wherein said second tube is comprised of a metal alloy.

7. The transmission line according to claim 1, further comprising:
a second layer of insulating material covering said conductive material.

8. The transmission line according to claim 1, further comprising:
an epoxy resin injected between said layer of insulating material and said second tube.

9. The transmission line according to claim 1, further comprising:
a protective layer surrounding said second tube.

10. The transmission line according to claim 1, further comprising:
at least a second or more conductive material layer wrapped or braided around said first tube.

11. The transmission line according to claim 10, further comprising:
a layer of insulation separating each of said conductive material layer.

12. A method of making a transmission line comprising the steps of:
providing at least one polymeric or glass fiber;
surrounding said fiber with a first containment tube;
wrapping or braiding a conductive material around said first tube;
covering said conductive material with a layer of insulating material; and
surrounding said material with a second containment tube.

13. The method of making a transmission line according to claim 12, wherein said fiber is of optical quality.

14. The method of making a transmission line according to claim 12, wherein said first tube is comprised of stainless steel.

15. The method of making a transmission line according to claim 12, wherein said conductive material is comprised of copper braiding.

16. The method of making a transmission line according to claim 12, wherein said insulating material is comprised of a thermoplastic.

17. The method of making a transmission line according to claim 12, wherein said second tube is comprised of a metal alloy.

18. The method of making a transmission line according to claim 12, further comprising the step of:
covering said conductive material with a second layer of insulating material.

19. The method of making a transmission line according to claim 12, further comprising the step of:
injecting an epoxy resin between said layer of insulating material and said second tube.

20. The method of making a transmission line according to claim 12, further comprising the step of:
surrounding said second tube with a protective layer.

21. The method of making a transmission line according to claim 12, further comprising the step of:
wrapping or braiding at least a second or more conductive material layer around said first tube.

22. The method of making a transmission line according to claim 21, further comprising the step of:
separating each of said conductive material layer with a layer of insulation.

23. A transmission line suitable for use in well monitoring comprising:
at least one polymeric or glass fiber of optical quality;
a first stainless steel containment tube surrounding said fiber;
a copper braiding wrapped around said first tube;
a first layer of thermoplastic insulating material covering said copper braiding;
a second layer of thermoplastic insulating material covering said copper braiding;
a second metal alloy containment tube surrounding said first and second layer of insulating material; and
a protective layer surrounding said second tube.

24. A transmission line suitable for use in well monitoring comprising:
at least one polymeric or glass fiber of optical quality;
a first stainless steel containment tube surrounding said fiber;
a copper braiding wrapped around said first tube;
a layer of thermoplastic insulating material covering said copper braiding;
a second metal alloy containment tube surrounding said layer of insulating material;
an epoxy resin injected between said layer of insulating material and said second tube; and
a protective layer surrounding said second tube.

25. A well for producing oil or gas from an oil or gas reservoir, said well comprising:
a hole drilled from the earth's surface to the oil or gas reservoir;
a casing constructed and arranged to line said hole;
a string of production pipe or tubing constructed and arranged to pass through said casing to the oil or gas reservoir;
means for transferring oil or gas into the production tubing or pipe located on said plurality of pipe or tubing sections; and
a data transmission line constructed and arranged to pass between said casing and said plurality of pipe or tubing sections;
said data transmission line including:
at least one polymeric or glass fiber;
a first containment tube surrounding said fiber;
a conductive material wrapped or braided around said first tube;
a layer of insulating material covering said conductive material; and
a second containment tube surrounding said material.

26. A system for sensing and recording physical parameters over an extended distance, said system comprising:
means for receiving and recording signals representative of the physical parameters;
means for sensing the physical parameters; and
a data transmission line for connecting said means for sensing said physical parameters and said means for receiving and recording signals representative of the physical parameters;
said data transmission line including:
at least one polymeric or glass fiber;
a first containment tube surrounding said fiber;
a conductive material wrapped or braided around said first tube;
a layer of insulating material covering said conductive material; and
a second containment tube surrounding said material.

27. The system according to claim 26, further comprising:
a stationary box for containing a coil of said data transmission line.

28. The system according to claim 26, further comprising:
a pulley for directing the travel path of said data transmission line to said sites at which the physical parameters are measured.

29. A method of using a data transmission line for well monitoring, said method comprising:
measuring the properties of earth formations penetrated by wellbores with one or more instruments, said instruments generating signals in response to the properties of the earth formations; and
transmitting said signals with a data transmission line to a computer for processing and interpretation of said signals,
said data transmission line including:
at least one polymeric or glass fiber;
a first containment tube surrounding said fiber;
a conductive material wrapped or braided around said first tube;
a layer of insulating material covering said conductive material; and
a second containment tube surrounding said material.
